(19) United States
(12) Patent Application Publication
(10) Pub. No.: US 2007/0116598 A1
(43) Pub. Date: May 24, 2007

(54) Microfluidic system

(75) Inventors: Ian Hughes, Harlow (GB); Brian Herbert Warrington, Harlow (GB); Yuk Fan Wong, Harlow (GB)

Correspondence Address: GLAXOSMITHKLINE;CORPORATE INTELLECTUAL PROPERTY, MAI B475, FIVE MOORE DR., PO BOX 13398, RESEARCH TRIANGLE PARK, NC, 27709-3398, US

(73) Assignee: GLAXO GROUP LIMITED, Middlesex (GB)

(21) Appl. No.: 10/550,939

(22) PCT Filed: Apr. 7, 2004
(86) PCT No.: PCT/GB04/01513

§ 371 Date: Sep. 28, 2005

(30) Foreign Application Priority Data
Apr. 7, 2003 (GB) 0307999.3

(51) Int. Cl. G01N 31/00

(52) U.S. Cl. 422/62; 422/67

(57) ABSTRACT

A system having a microfluidic channel structure in which fluids are able to interact to produce at least one product, and an automated closed-loop control mechanism to autonomously control a condition in, or of, the channel structure, the control mechanism having a sensor adapted to produce a sensor signal representative of a predetermined property of the at least one product which is dependent on the condition in, or of, the channel structure, means adapted to vary the condition in, or of, the channel structure, and a computer which is adapted to receive the sensor signal and to cause the means to vary the condition in, or of, the channel structure in dependence of the sensor signal is disclosed.

### RELATED APPLICATION

The present application claims priority from UK patent application No. 0 307 999.3 filed on 7 Apr. 2003, the entire content of which is hereby incorporated herein by reference.

1. Field of the Invention

The present invention relates to a microfluidic system and to methods performed on the system.

2. Background of the Invention

The use of microfluidic systems is now well established in a variety of disciplines, including analytical chemistry, drug discovery, diagnostics, combinatorial synthesis and biotechnology. Such systems also have important applications where sample volumes may be low, as might be the case in the synthesis or screening of combinatorial libraries, in post-genomic characterisations etc.

The microfluidic systems have a microfluidic channel structure of small dimension in which the flow rates of liquids therein are relatively high. This leads to faster and cheaper analysis and/or synthesis within a smaller footprint. A characteristic effect observed in the microfluidic channel structure is the inherently low Reynolds Number (Re<700) which gives rise to laminar flow of the liquid. This effect can be most clearly seen when two flowing streams, from different channels, meet to traverse along a single channel, resulting in the streams flowing side-by-side. The net result of this phenomenon is that there is no turbulence and mass transfer between the two streams takes place by diffusion of molecules across the interfacial boundary layer. The diffusional mixing across this interface can be fast, with times for mixing ranging from milliseconds to seconds. The diffusion mixing time is even shorter if there is reactivity between the flow streams.

The microfluidic channel structure of a microfluidic system may be formed in a microfluidic chip or be formed by a capillary structure.

As background art there may be mentioned EP-A-1 336 432, which was published after the priority date of this application.

### Summary of the Invention

According to the present invention there is provided a system having a microfluidic channel structure in which fluids are able to interact to produce at least one product, and an automated closed-loop control mechanism to autonomously control a condition in, or of, the channel structure, the control mechanism having:

a sensor adapted to produce a sensor signal representative of a predetermined property of the at least one product which is dependent on the condition in, or of, the channel structure,

means adapted to vary the condition in, or of, the channel structure, and

a computer which is adapted to cause the means to vary the condition in, or of, the channel structure in dependence of the sensor signal.

Typically, the computer is programmed with a predetermined objective which is related to the predetermined property and the computer is adapted to compare the sensor signal with the predetermined objective and to cause the means to vary the condition in, or of, the channel structure based on the comparison in pursuit of attaining the predetermined objective.

The channel structure may be a flow channel structure in which the fluids are flowable to interact.

Suitably, the fluids react in the channel structure to produce at least one reaction product, i.e. the fluids are reagents. The term “reagent” in this application includes a fluid (e.g. liquid) which is a reagent and a fluid (e.g. liquid) which contains one or more reagents.

The microfluidic channel structure may be formed in a microfluidic chip. The sensor of the system may form a part of the chip, or be separate therefrom.

The sensor may be a separate element in which case the system may have an automated transfer mechanism for transferring the at least one product to the sensor.

The sensor of the system may be one of a plurality of different sensors of the system, each sensing a different property of the at least one product. The computer then varies the condition taking account of all of the independent sensor signals.

The closed-loop control mechanism of the system may be adapted to autonomously control a plurality of different conditions in and/or of the channel structure. These conditions may be varied in dependence of sensor signals from a single sensor or from a plurality of sensors. In one case, each condition may be varied in dependence of a different sensor in a sensor array of the system.

The means may be adapted to vary a physical condition in the channel structure, e.g. temperature, pressure, flow rate, electric field etc.

The means may be adapted to vary a physical condition of the channel structure, e.g. geometry, nature of channel surface, channel surface potential etc.

The means may be adapted to vary a chemical condition in the channel structure, for example the chemical composition of the fluids, the pH of the fluids, solid phases in or on the channel structure, concentration, etc. The means may be adapted to vary electropheretic movement of ions in the channel structure through electrodes introduced in the channel structure.

The means may be adapted to vary a chemical condition of the channel structure, e.g. by surface treatment of the channel structure, for instance by chemical modification or by a payload which may be released by a ‘catch and release’ mechanism, as known in chemical technology.

The channel structure may have a flow channel and more than two inlets thereto, at least one inlet being located downstream of one of the other inlets, and the means to vary is adapted to be controlled by the computer to vary the sequence and/or timing and/or point of introduction of the fluids into the flow channel through the inlets in dependence of the sensor signal. As an example, the sequence may be varied by varying the relative timings of the introductions or the relative flow rates through the inlets, or by changing the inlets through which the fluids are introduced into the flow channel, i.e. swapping the inlets for the fluids around. This is an example of how the geometry of the channel structure may be varied.

Other aspects and features of the invention are set forth in the claims and the description of exemplary embodiments which now follows.

### BRIEF DESCRIPTION OF THE DRAWINGS

FIG. 1 is a schematic, fragmentary plan view of a microfluidic chip showing its microfluidic channel structure.

FIG. 2 is a schematic, block diagram of a system of the invention.

FIG. 3 is a schematic, fragmentary plan view of the microfluidic chip, but with another microfluidic channel structure.

### DETAILED DESCRIPTION OF THE DRAWINGS

In the following description, like reference numerals are used to denote like features in the different embodiments.

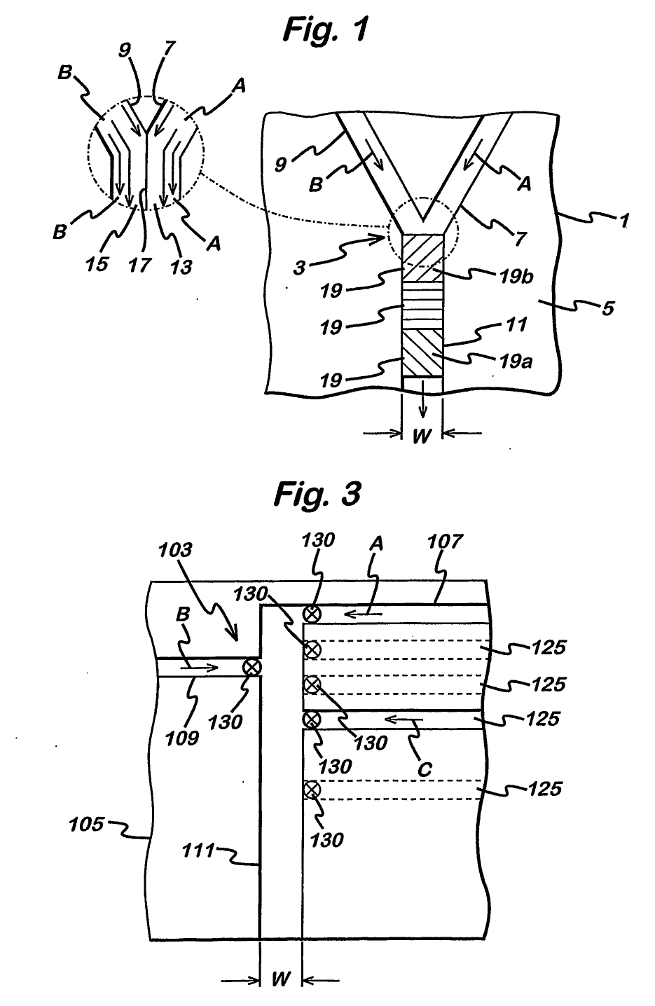

In FIG. 1 there is schematically shown a typical microfluidic chip 1 having a Y-shaped microfluidic channel structure 3 provided in an external chip surface 5. The chip 1 is formed from silicon, silica or glass and the channel is provided therein by wet (chemical) or dry (e.g. plasma) etching, as known in the art. The chip could also be formed from a plastics material.

The channel structure 3 has a pair of inlet branch channels 7,9 for the concurrent introduction of two reagents A,B into a common flow channel 11. The channels 7,9,11 are of dimensions which will enable them to sustain a low Reynolds Number with laminar flow therein (Re<700, preferably Re<10). To this end, the channels are preferably of a width W of no more than 300 microns. The depth of the channels 7,9,11 is typically no more than the width, and more typically less than the width by 50% or more (i.e. an aspect ratio of width-to-depth of at least 2:1).

The low Reynolds Number in the channel structure 3 results in the reagents A,B flowing laminarly in the common flow channel 11 in parallel or side-by-side flow streams 13,15, as shown in the inset of FIG. 1. The net result of this phenomenon is that there is no turbulence and mass transfer between the two flow streams 13,15 takes place by diffusion of molecules across the interfacial boundary layer 17.

The length of the side-by-side flow streams 13,15 from the point of coincidence of the inlet branch channels 7,9 depends on the reactivity of the reagents. As shown in FIG. 1, interaction of the flow streams 13,15 results in the development of a series of “reaction domains” 19 forming in the common flow channel 11, which may be of different colour, for example.

The reaction domains 19 contain different reaction products and correspond to the different stages of the complete reaction of the reagents A,B. In other words, a time resolution of the reaction of A and B is able to observed in the common flow channel 11. This is due to the different residence times of the reaction domains 19 in the common flow channel 11. In other words, at a given point in time the leading domain 19a has had a longer residence in the common flow channel 11 than the trailing domain 19b. Thus, the interaction between the reactive components of the reagents A,B in the leading domain 19a will have progressed more than in the trailing domain 19b.

Heterogeneous reactions of the aforementioned type can be carried out in different modes. In Mode I, a continuous flow of reagents A,B interact at the point of coincidence of inlet branch channels 7,9 and attain a steady state in the common flow channel 11 such that the reaction domains 19 appear to be stationary therein. In Mode II, on the other hand, discrete plugs of reagents A,B of short duration are released in the respective inlet branch channels 7,9 into continuous non-reacting solvent flow streams and react in a heterogeneous manner in the common flow channel 11, as in Mode I, but fail to attain the steady state achieved in Mode I. In Mode III, one of the reagents is pulsed into a continuous non-reacting solvent flow stream whilst a continuous flow stream of the other reagent is provided.

If the carrier liquids or reagents are immiscible, different reaction domains can be formed in different phases.

As an example of steady state Mode I, consider the case where reagent A is aqueous potassium permanganate and reagent B is an alkaline aqueous ethanol solution. The reaction domains 19 are of different characteristic colours which correspond to those known for the stepwise reduction of the potassium permanganate with the alkaline ethanol.

As an example of Mode II, a plug of benzyl phosphonium bromide (reagent A) is released into a non-reacting continuous solvent flow stream in one of the inlet branch channels 7 (e.g. methanol) while a plug of a mixture of aryl aldehyde and a base, e.g. sodium methoxide, (reagent B) is released into a non-reacting continuous solvent flow stream (e.g. methanol) in the other inlet branch channel 9. This results in a heterogeneous reaction in the common flow channel 11 which emits a plug of the stilbene reaction product.

An example of Mode III is a Suzuki reaction in which variable plugs of an aryl halide are released into a continuous flow stream of an aryl boronic acid within a catalysis-lined common flow channel 11.

As will be appreciated, the inlet branch channels 7,9 could form other shapes with the common flow channel 11 instead of the Y-shape, for instance a T-shape.

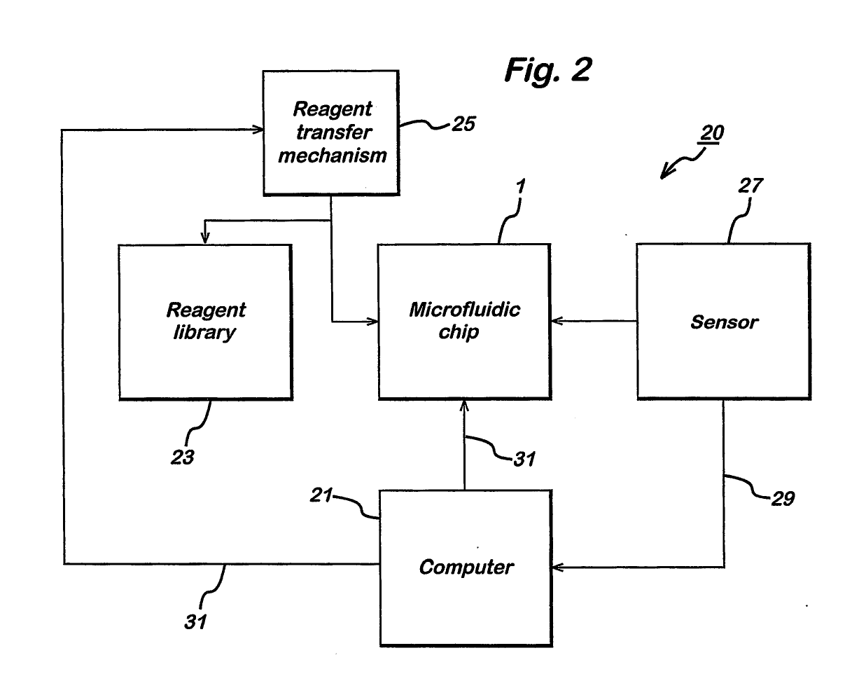

A computer-controlled system 20 of the present invention incorporating the microfluidic chip 1 is shown schematically in FIG. 2. The system is controlled by a computer 21 which is operatively coupled to the microfluidic chip 1. The computer 21 is of a standard PC format running a Windows® operating system (Microsoft Corporation, USA) with a Pentium® 4 processor (Intel Corporation, USA).

The system 20 further comprises a reagent library 23, which may have only two reagents or a greater number of reagents, depending on the process to be carried out on the system 20. Where the reagent library 23 contains a large number of different reagents, the library takes the form of a categorised reagent array, such as described by Caliper Technologies Corporation (California, USA) as “LibraryCard”. As an alternative, the reagents in the categorised reagent array may be in tubes or the wells of one or more plates (e.g. microtitre plate(s)).

The reagent library 23 is operatively coupled to the microfluidic chip 1 through a transfer mechanism 25. The transfer mechanism may take the form of capillaries extending from the reagents to the inlet branch channels 7,9 of the chip 1 or a small volume dispensing device, for example the ‘sipper chip’ available from Caliper Technologies Corporation(USA).

Finally, the system 20 has a sensor 27 for producing a sensor signal representative of a predetermined property of the reaction product formed in the common flow channel 11 of the chip 1. The sensor 27 may take on various forms, such as passive or interventative, depending on the intended operation of the system 20, as will be understood hereinafter. The sensor may form a part of the chip 1.

The sensor 27 produces sensor signals 29 which are representative of the predetermined property of the reaction product and feeds these back to the computer 21 for processing thereof.

As described in more detail hereinafter, the computer 21 utilises an iterative algorithm to cause the system 20 to operate to produce, or attempt to produce:
(i) an optimisation of reaction conditions in the common flow channel 11, for example to optimise yield or produce a specific outcome, or
(ii) a reaction product in the common flow channel 11 in which the predetermined property is sensed by the sensor 27, or is sensed to be of a predetermined value.

In this regard, the computer 21 and sensor 27 form an automated closed-loop control (or feedback-loop control) of the system 20. By way of explanation, the sensor signal 29 is processed by the computer 21 and results in a demand signal 31 being output by the algorithm which is responsive to the sensor signal 29. The demand signal 31 is used to cause a change in a condition in and/or of the chip channel structure 3. More particularly, the demand signal 31 may be used to vary the conditions experienced by the reagents in the chip channel structure 3, for instance flow rate, temperature, pressure, . . . etc. Alternatively, or additionally, the demand signal 31 may be used to change one or more of the reagents transferred from the library 23 to the microfluidic chip 1. In the latter case, the method of selecting a replacement reagent by the algorithm will be facilitated by the categorisation applied to the reagent library 23 (which categorisation will be programmed in the computer 21) such that the algorithm is able to select the reagent which most closely resembles the reagent it predicts to be necessary from a most suitable search.

The system 20 thus appears to “intelligently” and heuristically vary the parameters of the reaction in the chip 1 so as to seek to obtain the goal or multiple goals of the algorithm, e.g. an optimisation of one or more properties of the reaction product. To this end, the algorithm may be a Simplex algorithm or a genetic algorithm or a combination thereof. Instead of, or as well as, an algorithm, a neural network could be used.

Various Examples of the use of the system 20 will now be given.

### EXAMPLE 1

### Chemical Sensor

In this Example, the system 20 is used to optimise a chemical property of the reaction, e.g. the yield of a specific reaction product in the reaction of reagents A and B, the relative amounts of time-resolved reaction or product domains 19, or the amount of a particular isomer.

In this case, the sensor 27 takes the form of a chemical sensor, e.g. an on-line sensor or an off-line sensor, such as an imaging apparatus, a Raman spectroscope or a liquid chromatography-mass spectrometer. When the sensor signal 29 indicates that the yield of the reaction product is not at the set point level in the algorithm, the demand signal 31 is fed either to the transfer mechanism, to vary the flow rate of the reagents for example, and/or to the chip 1 (which in this instance includes any associated equipment for controlling the ambient conditions of the chip 1) to cause a change to another condition in the channel structure 3, e.g. the temperature, etc.

Where several reaction products are being monitored simultaneously in the common flow channel 11, these can be discriminated from one another by determining their molecular weight with mass spectroscopy. This applies generally to the operation of the system 20.

Alternatively, or additionally, the library 23 includes the same reagents, but in different concentrations etc. The demand signal 31 causes the transfer mechanism 25 to vary the reagent combination input to the chip 1.

### EXAMPLE 2

### Biosensor

In this Example the system 20 is used to run a variety of different reagent combinations through the chip 1 and to pass the reaction products through one or more biosensors to test for their possible use in pharmaceutical applications, e.g. drug discovery. In other words, the system 20 is used for high throughput screening (HTS) of the reaction products. Here the closed-loop control operates to find a reaction product from the reagent library 23 for further investigation for pharmaceutical application.

The biosensor(s) may comprise a bioassay and one or more detectors for detecting the interaction of the reaction product with the bioassay and outputting the sensor signal 29. In this regard, the bioassay may be bead-based, and may comprise a plurality of different bioassay beads. The detector(s) may comprise an imaging apparatus or other type of optical radiation detector(s), e.g. a Nikon TE2000U used with a confocal fluorescence detector (available from Genapta Limited, Cambridgeshire, UK).

A plurality of biosensors may be used, for example through a manifold system which provides an output product to a variety of bioassays or through a multiplexed bioassay where discrimination can be based on, for example, an encoded bead-based system or a bioassay array, for instance an array of holographic sensors (Smart Holograms Limited, Cambridge, UK)

The system 20 operates to vary the reagent combination input to the chip 1 in response to the sensor signals 29 representative of the preceding reaction product to optimise the reaction product vis-a-vis the biosensor(s). The selection of the “new” reagent or reagents by the computer 21 is facilitated by the categorisation of the reagents in the reagent library 23 (see above).

### EXAMPLE 3

In this Example, the chip 1 of the system 20 has the channel structure 103 schematically shown in FIG. 3. The channel structure 103 has the inlet branch channel 107 for reagent A and the inlet branch channel 109 for reagent B which in this case is offset (downstream) from inlet branch channel 107. The channel structure 103 further has one or more additional inlet branch channels 125 for another reagent C. Each inlet branch channel 107,109,125 has a valve 130 so as to be independently operable. Again, laminar flow streams are produced in the common flow channel 111.

In this way, the reaction products in selected reactions domains (19, FIG. 1) can be reacted with the reagent C by synchronizing the opening of the inlet branch channel(s) 125 with apposition of the selected reaction domain therewith. Selectivity of a reaction domain for reaction with the new reagent C is assisted by having a series of inlet branch channels 125 (shown in ghost in FIG. 3) so that the time-resolved reaction domains 19 are not “lost” before passing one of the inlet branch channels 125 for reagent C.

Thus, the closed-loop control can operate to vary the time-resolved reaction domain 19 that reacts with reagent C to optimise the reaction product. vis-a-vis the sensor 27, or to vary the dwell time of a particular reaction domain before it is reacted with reagent C, e.g. by control of the flow rate by the computer, for instance by control of pressure pumps (Eksigent Technologies, USA) associated with the chip. In this way, the optimal point of entry of reagent C is found.

It will be appreciated that this operation has application for each of Modes I-III detailed above.

Moreover, an inlet arrangement of the sort shown in FIG. 3 enables the order of mixing of a plurality of reagents to be varied by the system 20 by enabling the computer 21 to cause the reagents (e.g. A-C) to be input through different inlet branch channels 107,109,125 in each new cycle thereof. In other words, the inlets used for the reagents are swapped around to find the optimal arrangement.

It will be understood that the present invention is not limited to the specific embodiments hereinabove described, but may take on may other guises, forms and modifications within the scope of the appended claims. As an example, the channel structures described with reference to FIGS. 1 to 3 could be formed by a capillary network instead of in a chip. As another example, the system may pass the product through more than one sensor for determination of more than one property thereof and the computer operates to vary the condition in and/or of the channel structure in response to all of the sensor signals, e.g. to seek to maximise one or more product properties and/or minimise one or more product properties. Moreover, two or more optimising systems can be linked together. Additionally, optimisation can be sought over several stages of a reaction which stages may or may not be individually optimised. Each stage of the reaction may be carried out in the same microfluidic channel structure, e.g. be re-circulating the intermediate product of each stage back into the channel structure for further processing.

1. A system having a microfluidic channel structure in which fluids are able to interact to produce at least one product, and an automated closed-loop control mechanism to autonomously control a condition in, or of, the channel structure, the control mechanism having:
a sensor adapted to produce a sensor signal representative of a predetermined property of the at least one product which is dependent on the condition in, or of, the channel structure,
means adapted to vary the condition in, or of, the channel structure, and
a computer adapted to receive the sensor signal and to cause the means to vary the condition in, or of, the channel structure in dependence of the sensor signal.

2. The system of claim 1, wherein the sensor is adapted to produce a sensor signal representative of a predetermined chemical property of the at least one product.

3. The system of claim 1, wherein the sensor is adapted to produce a sensor signal representative of a predetermined biological property of the at least one product.

4. The system of claim 1, wherein the means is adapted to vary a physical condition in, or of, the channel structure.

5. The system of claim 1 having a transfer mechanism to transfer reagents from an array of reagents to the channel structure.

6. The system of claim 5 in which the operation of the transfer mechanism is controlled by the computer.

7. The system of claim 5 further including the reagent array.

8. The system of claim 5 wherein the means to vary the condition in the channel structure is the transfer mechanism, the computer being adapted to cause the transfer mechanism to change the reagent combination in the channel structure in dependence of the sensor signal.

9. The system of claim 1, wherein the channel structure has a flow channel and more than two inlets thereto, at least one inlet being located downstream of one of the other inlets, and the means to vary is adapted to be controlled by the computer to vary the sequence and/or timing and/or point of introduction of fluids into the channel through the inlets in dependence of the sensor signal.

10. The system of claim 1 whose operation is fully automated.

11. The system of claim 1, wherein the computer is programmed to operate the control mechanism to produce a product of which the predetermined property satisfies a predetermined objective.

12. The system of claim 11, wherein the predetermined property is a chemical property and/or a physical property and/or a biological property.

13. The system of claim 1 provided that the control mechanism is not adapted to control a condition in the channel structure to provide an optimised yield of a product.

14. The system of claim 11, wherein the predetermined property is a chemical property and the predetermined objective relates to identity, purity, conversion, isomeric ratio, yield, impurity profile or colour.

15. The system of claim 11, wherein the predetermined property is a biological property and the predetermined objective relates to activity, potency, selectivity or duration.

16. The system of claim 1, wherein the control mechanism is adapted to control a condition of the channel structure.

17. The system of claim 16, wherein the condition of the channel structure is the geometry thereof.

18. The system of claim 1 which is an integrated, computer-controlled system.

19. A method of screening of chemical compounds implemented on the system of claim 1.

20. A method of screening of chemical compounds implemented on the system of claim 11 comprising providing an array of chemical compounds and programming the computer to operate the closed-loop control mechanism to autonomously run different combinations of the compounds through the microfluidic channel structure until a compound combination results in a product having a predetermined biological property which satisfies a predetermined objective.

21. The method of claim 20 in which the compound array is categorised.

22. The method of claim 19 in which the computer operates the control mechanism heuristically.

23. A method of optimising a predetermined property of a product implemented on the system of claim 1.
